(19) United States
(12) Patent Application Publication
(10) Pub. No.: US 2020/0285252 A1
(43) Pub. Date: Sep. 10, 2020

(54) METHODS AND APPARATUS TO CREATE DRONE DISPLAYS

(71) Applicant: Intel Corporation, Santa Clara, CA (US)

(72) Inventors: Daniel Gurdan, Germering (DE); Tobias Gurdan, Germering (DE)

(21) Appl. No.: 16/646,088

(22) PCT Filed: Dec. 27, 2017
(86) PCT No.: PCT/US17/68550

§ 371 Date: Mar. 10, 2020

(51) Int. Cl. G05D 1/10; G09F 21/10; B64C 39/02

(52) U.S. Cl. CPC G05D 1/104; B64C 39/02; G09F 21/10

(57) ABSTRACT

Methods and apparatus to create drone displays are disclosed. An example drone display design system includes an audience configuration definer to receive an input representing a configuration of an audience from a user, and a drone display designer to, by executing an instruction with a processor, design a drone display to present content to the audience based on the input.

### FIELD OF THE DISCLOSURE

This disclosure relates generally to drones, and, more particularly, to methods and apparatus to create drone displays.

### BACKGROUND

In recent years, unmanned aerial vehicles (UAVs) (e.g., drones) have become available as commercial and recreational devices.

### BRIEF DESCRIPTION OF THE DRAWINGS

FIG. 1 illustrates an example drone display system constructed in accordance with teachings of this disclosure, and shown in an example environment of use.

FIG. 2 is a block diagram illustrating an example implementation of the example drone display design system of FIG. 1.

FIG. 3 is a block diagram illustrating an example implementation of the example flight system of FIG. 1.

FIG. 4 is a flowchart representative of example hardware logic or machine-readable instructions for implementing the drone display design system of FIG. 2.

FIG. 5 illustrates an example processor platform structured to execute the example machine-readable instructions of FIG. 4 to implement the example drone display design system of FIGS. 1 and/or 2.

In general, the same reference numbers will be used throughout the drawing(s) and accompanying written description to refer to the same or like parts. Connecting lines or connectors shown in the various figures presented are intended to represent example functional relationships and/or physical or logical couplings between the various elements.

### DETAILED DESCRIPTION

Presenting images and videos (pre-taped or live) to large audiences (e.g., at a concert, in a stadium, at an outdoor venue, in an indoor venue, at an outdoor aquatic event, at a race, etc.) can be challenging. Physical screens must be installed, which are directed toward certain viewing areas, and may be visible to only a subset of the audience. To overcome these challenges, a fleet of choreographed, flying, light-emitting UAVs (e.g., drones) can be used to create drone displays (e.g., a static and/or moving virtual video screens in the air). In some examples, a drone display is partially or wholly formed by drones on a static surface such as a hillside. Drone displays can be tilted, curved, spherical, two-dimensional (2D), three-dimensional (3D), geometric, non-geometric, etc. In some examples, drone displays are easily viewed, easily customizable, reusable, etc.

In some examples, drone displays have configurable resolutions, are dynamically locatable (e.g., movable between various positions), are arbitrarily shaped (e.g., geometric, non-geometric, etc.), are dynamically shaped (e.g., a shape that is morphing, changing, etc.), and/or are dynamically sizable. Compared to conventional physical screens, some drone displays can be dynamic entities that can move, change and/or be part of a presented show. In some examples, the configuration of an audience can be tracked or known a priori and used to adapt a drone display. A non-limiting example of a drone display has a shape (e.g., a hemisphere, a dome, a cone, etc.) of drones hovering above a large crowd displaying spherical (e.g., 360 degree) videos, wind and weather data, and/or stellar and planetary constellations

To improve the creation of drone displays, examples disclosed herein can, among other aspects, automatically optimize the number, position, shape, size of the drone display(s) based on the configuration of a venue, and map content (e.g., an image, a video stream, a generated pattern, etc.) onto the automatically optimized drone display. That is, disclosed examples assist in the planning of a drone display, enable the dynamic mapping of content to a 2D or 3D drone display, and can adapt the geometry of drone displays as an audience moves. Most known content mapping solutions are limited to the mapping of content onto 2D displays.

Reference will now be made in detail to non-limiting examples, some of which are illustrated in the accompanying drawings.

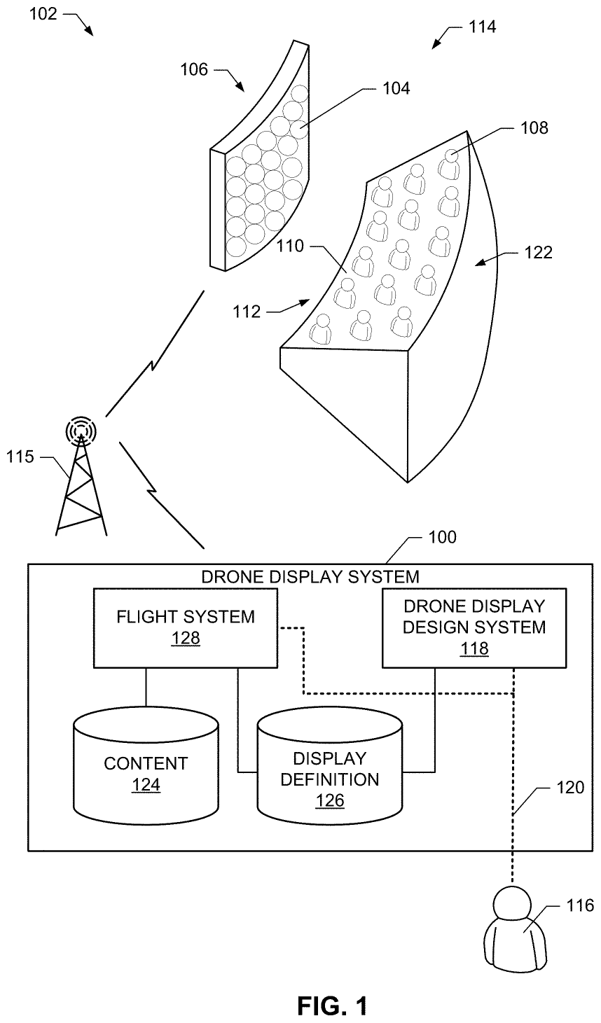

FIG. 1 illustrates an example drone display system 100 constructed in accordance with teachings of this disclosure, and shown in an example environment of use 102. The example drone display system 100 of FIG. 1 controls any number and/or type(s) of UAVs (e.g., drones 104) to form an example drone display 106 on which content is displayed. In some examples, the drones 104 are colored, illuminated, reflective, shaped, etc. in one or more directions to form the example drone display 106. In some examples, a drone 104 can display assorted colors in different directions. The example drone display 106 is shaped, sized, positioned, etc. to be viewed by persons 108. In the illustrated example of FIG. 1, the persons 108 are positioned in the stands 110 of a portion 112 of a stadium 114. In the illustrated example of FIG. 1, the drone display system 100 controls the drones 104, and/or, more generally, the drone display 106 via a cellular telephone tower 115, a wireless access point (AP), a wireless hotspot, etc. Additionally, and/or alternatively, the drones 104 are programmed by the drone display system 100, including any applicable safety precautions, and flown autonomously.

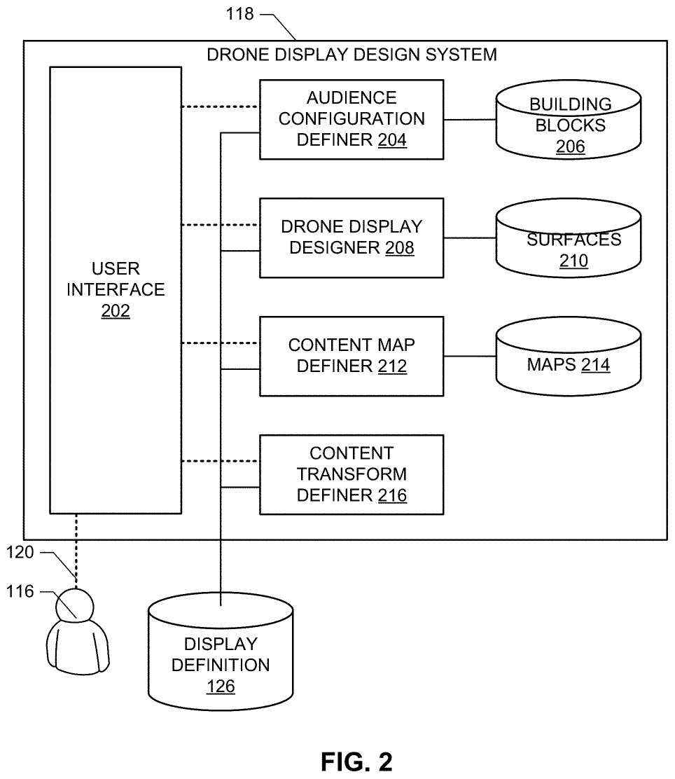

To enable a user 116 to design one or more aspects of the example drone display 106, the example drone display system 100 of FIG. 1 includes an example drone display design system 188. In some examples, the drone display design system 118 includes a collection of standalone applications (e.g., see FIG. 2), a collection of integrated applications (e.g., see FIG. 2), etc. accessed via, for example, a user interface 202 (FIG. 2). In some examples, the applications (e.g., see FIG. 2) are web-based applications integrated to form a web-based drone design display portal. In some examples, the applications (e.g., see FIG. 2) are standalone applications integrated to present the appearance of an integrated solution. The user 116 via, for example, the user interface 202a of the example drone display design system 188 of FIG. 1, provides input(s) 120 that represent the configuration of an audience 122. Example inputs 120 include, but are not limited to, the number of rows of audience members 108 (e.g., three rows shown in FIG. 1), the rows arranged on an upwardly sloped audience stand 112, the rows extending along a curved stadium 114. The user 116 may, for example, also provide additional inputs 120 such as the angle of the sloped audience stand 112, the radius of the curved stadium 114, etc. Example inputs may, additionally, and/or alternatively, include design constraints and/or desired aspects of the drone display 106 such as, shaped (e.g., curved as shown in FIG. 1), one-sided or more than one sides, viewing angle (e.g., an audience member 108 doesn't have to look upward by more than N feet, or M feet left or right), etc. In some examples, some such inputs 120 are selected from a plurality of options and/or examples.

To design the drone display 106, the example drone display system 100 includes the example drone display design system 188. As described below in connection with FIG. 2, the example drone display design system 188 of FIG. 1 uses the inputs 120 provided by the user 116 to design the drone display 106 and to map content 124 onto the drone display 106. In this way, the drone display design system 188 assists the user 116 in the design of the drone display 106. In some examples, the drone display design system 118 uses optimization techniques to design the drone display 106.

In some examples, the drone display design system 188 stores the designed drone display 106 in a display definition datastore 126 ahead of the drone display 106 being activated. In some examples, the drone display 106 is designed in real time as the drone display 106 is being used. The design of the drone display 106 may be stored in the example display definition datastore 126 using any number and/or type(s) of data structures on any number and/or type(s) of computer-readable storage device or memory.

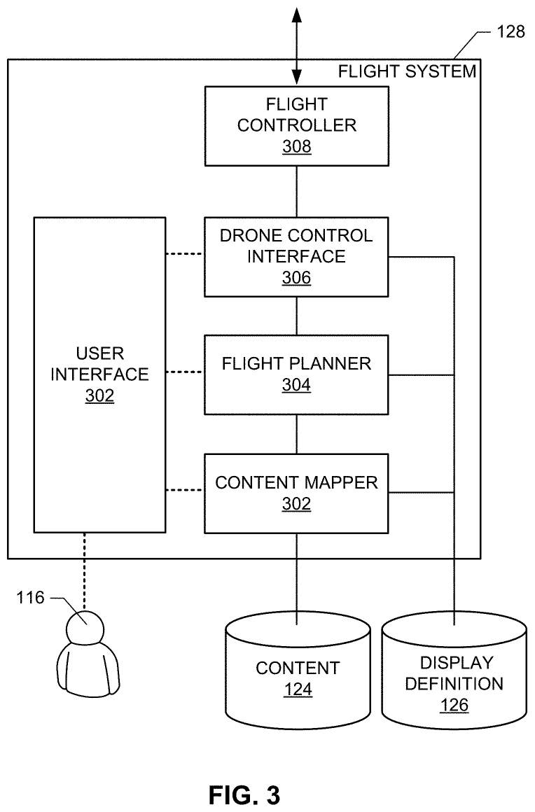

To activate (e.g., fly, begin displaying content, start, etc.) the example drone display 106, the example drone display system 100 includes an example flight system 128. As described below in connection with FIG. 3, the example flight system 128 maps the content 124 (e.g., a movie, a replay, a live view of an event, etc.) onto the drone display 106 specified by the display definition 126, and activates the drone display 106. In some examples, the drone display 106 being activated by the flight system 128 has been pre-determined. In some examples, the drone display 106 is designed in real time by the drone display design system 188, with the flight system 128 activating the drone display 106 substantially as the drone display design system 188 designs the drone display 106. In some examples, the user 116 can control the activation of the drone display 106 via, for example, a user interface 302 (FIG. 3). The content 124 may be stored using any number and/or type(s) of data structures on any number and/or type(s) of computer-readable storage device or memory.

While an example manner of implementing the example drone display system 100 is illustrated in FIG. 1, one or more of the elements, processes and/or devices illustrated in FIG. 1 may be combined, divided, re-arranged, omitted, eliminated and/or implemented in any other way. Further, the example drone display design system 100 of FIG. 1 may include one or more elements, processes and/or devices in addition to, or instead of, those illustrated in FIG. 1, and/or may include more than one of any or all the illustrated elements, processes and devices.

FIG. 2 is a block diagram illustrating an example implementation of the example drone display design system 188 of FIG. 1. To enable the user 116 to provide input(s) 120 representing the configuration of an audience, the example drone display design system 188 of FIG. 2 includes an example audience configuration definer 204. Via the user interface 202, the example user 116 interacts with the audience configuration definer 204 to provide input(s) 120 that represent one or more configuration aspects (e.g., arrangement, positions, etc.) of the audience 122, obstacles (e.g., trees, manmade structures), etc. Example inputs 120 include, but are not limited to, the number of rows of audience members 108 (e.g., three rows shown in FIG. 1), the rows are arranged on an upwardly sloped audience stand 112, the rows extending along a curved stadium 114. The user 116 may, for example, also provide additional inputs 120 such as the angle of the sloped audience stand 112, the radius of the curved stadium 114, etc. Example inputs may, additionally, and/or alternatively, include design constraints and/or desired aspects of the drone display 106 such as shape (e.g., curved as shown in FIG. 1), one-sided or more than one sides, viewing angle (e.g., an audience member 108 doesn't have to look upward by more than N feet, or M feet left or right), etc. In some examples, some or all the inputs 120 are selected from a plurality of options and/or examples (e.g., oval venue, two opposing audience stands, etc.) defined in a building blocks datastore 206, and presented by the audience configuration definer 204 for consideration by the user 116. In some examples, the building blocks datastore 206 includes lines (e.g., straight, curved, intersections, etc.) that the user 116 can combine via the user interface 202 to define an audience configuration. For example, to define an audience configuration for an urban demonstration, a festival, etc. that may have an irregular shape. In some examples, the user 116 may specify obstacles (e.g., trees, building structures, etc.). The building blocks 206 may be stored using any number and/or type(s) of data structures on any number and/or type(s) of computer-readable storage device or memory.

To design drone displays (e.g., the example drone display 106 of FIG. 1), the example drone display design system 188 of FIG. 1 includes an example drone display designer 108. Based on the audience configuration inputs 120, the example drone display designer 108 of FIG. 2 determines the viewing angles V of the audience 122. Additionally, and/or alternatively, in some examples, the user 116 specifies some or all the viewing angles V.

In some examples, the drone display designer 108 selects the shape and/or parameters of the drone display 106 from a set S of surface shapes 210 (e.g., planar, half-dome, sphere, curved, volumetric, etc.) most compatible with (e.g., best satisfies, provides the best coverage, etc.) the viewing angles V. For examples, the drone display designer 108 can use parameter optimization to identify the surface shape 210 and/or set of parameters (e.g., distance from audience, size, desired resolution, position, orientation, curvature, number of drones, etc.) that best fits the viewing angles V (e.g., maximizing the number of audience members 108 that can view the drone display 106 at a perpendicular angle). An example parameter optimization (e.g., find best solution) to design the drone display 106 can be expressed mathematically using the following minimization:

$$\vert \vert \frac{min arg}{{t}_{1} , parameters} {Σ}_{{v}_{i} ∈ V} {Σ}_{{s}_{j} ∈ {S}_{t}} C ( {v}_{i} , {s}_{j} , parameters ) \text{=·} X ( V ) .$$

Example cost functions C( ) include, but are not limited to deviation from a viewing angle of 90 degrees (C=0 for perpendicular, C>0 for non-perpendicular, and C=∞ otherwise), surface coverage (how much of a shape is viewable by audience members 108, user constraints, etc. In some examples, minimization (e.g., reduction) of X(V) can be solved for using optimization techniques using a stochastic gradient descent, the Euler-Lagrange differential equation, etc. The surfaces 210 may be stored using any number and/or type(s) of data structures on any number and/or type(s) of computer-readable storage device or memory.

Additionally, and/or alternatively, techniques from level set optimization and form finding of minimal networks using particle approximation can be applied to find a set of optimal anchors. The anchors can be used as projection geometries to select, and position pre-defined geometries can be used.

In some examples, machine learning is used to train a neural network to select drone display shape and/or parameters.

In some examples, the user 116 can, via the user interface 202, change one or more of the drone display shape and/or parameters designed by the drone display designer 208. In some examples, a good fit may not be found by the drone designer 208 in which case the user 116 may be presented with drone display shape options from which to select.

To map content onto the drone display shape and parameters, the example drone display design system 188 of FIG. 2 includes an example content map definer 212. In some examples, the user 116 via the user interface 202 selects a content mapping option. Example content mapping options include parameterization, projection mapping, slicing, etc. In an example of parameterization, mappings are known for many geometric shapes, can be approximated, and remain fixed for each drone, even during transformations. In an example of projection mapping, the mapping is like that used for projections onto buildings, screens, etc. However, projection is onto a virtual object that can deform and move, and which has not physical constraints. For example, cone-shape intersections may be used, using ray casting and closest point texture approximations. In some examples, physics-based particle simulation is used. In an example of slicing, a 2D projection surface is sliced through the drone display shape. In some examples, the slides are animated (e.g., a sequence that moves through a cube in layers as time advances). In some examples, the map(s) defined by the content map definer 212 is stored in a maps datastore 214 for subsequent recall.

An example benefit of drone displays is physical flexibility. Drone displays can move, rotate, change form, etc. Example scenarios include, a moving audience (e.g., screen following people), entertainment (e.g., moving screen from left to right for change of scenery), adjustment (e.g., four smaller screens targeted to different audience ranks coming together to form a bigger screen in the middle for half time), show element (drone display transitions from actual light show to media presentation screen), etc.

To incorporate drone display transforming (e.g., morphing, changing, etc.) the example drone display design system 188 of FIG. 2 includes an example content transform definer 216. The example content transform definer 216 of FIG. 2 transforms content with a fixed parameterization (image stretches with drone display shape), dynamic interpolate parameterization (e.g., images adjusts to drone display shape), dynamic projection mapping and slicing. The content transformation can be optimized for different viewing angles V, can change in real time as drone display shape changes (e.g., adaptive geometry), can morph between different drone display designs, etc.

In the illustrated example of FIG. 2, the example audience configuration definer 204, the example drone display designer 208, the example content map definer 212, and the example content transform definer 216 work, in turn, to define one or more drone display designs in the display definition datastore 126. For example, if more than one drone displays are to be activated at a venue, multiple drone displays would be defined in the display definition datastore 126.

While an example manner of implementing the drone display design system 188 of FIG. 1 is illustrated in FIG. 2, one or more of the elements, processes and/or devices illustrated in FIG. 2 may be combined, divided, re-arranged, omitted, eliminated and/or implemented in any other way. Further, the example audience configuration definer 204, the example drone display designer 208, the example content map definer 212, the example content transform definer 216 and/or, more generally, the example drone display design system 188 of FIG. 2 may be implemented by hardware, software, firmware and/or any combination of hardware, software and/or firmware. Thus, for example, any of the example audience configuration definer 204, the example drone display designer 208, the example content map definer 212, the example content transform definer 216 and/or, more generally, the example drone display design system 188 could be implemented by one or more analog or digital circuit(s), logic circuits, programmable processor(s), programmable controller(s), graphics processing unit(s) (GPU(s)), digital signal processor(s) (DSP(s)), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example audience configuration definer 204, the example drone display designer 208, the example content map definer 212, the example content transform definer 216 and/or the example drone display design system 188 is/are hereby expressly defined to include a non-transitory computer-readable storage device or storage disk such as a memory, a digital versatile disk (DVD), a compact disc (CD), a Blu-ray disk, etc. including the software and/or firmware. Further still, the example drone display design system 188 of FIG. 2 may include one or more elements, processes and/or devices in addition to, or instead of, those illustrated in FIG. 2, and/or may include more than one of any or all the illustrated elements, processes and devices. As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

FIG. 3 is a block diagram illustrating an example implementation of the example flight system 128 of FIG. 1. To map the content 124, the example flight system 128 of FIG. 3 includes an example content mapper 302. Based on a display definition 126, the example content mapper 302 of FIG. 3 maps the content 124 onto the drones 104 that form the drone display 106. For example, the content mapper 302 maps portions of the content 124 onto respective drones 104 based on a content map defined by the example content map definer 212 as modified, when applicable, by the example content transform definer 216. If more than one drone display 106 is to be used, the content mapper 302 of FIG. 3 maps a first portion of the content 124 onto a first set of drones 104, and a second portion of the content 124 onto a second set of drones 104.

To program drones with their flight plan and content to display, the example flight system 128 of FIG. 3 includes an example flight planner 304. The example flight planner 304 of FIG. 3 programs the drones 104 of the drone display 106 with the content determined by the content mapper 302 and their flight plan. The flight planner 304 programs the flight plans of the drones 104 based on the shape and/or parameters of the drone display 106, as stored in the display definition datastore 126.

To activate and fly a drone display, the example flight system 128 includes an example drone control interface 306. The example drone control interface 306 of FIG. 3 provides an interface for the flight planner 304 to send commands to the drones 104 to activate, control, fly, etc. the drones 104. In some examples, the drone control interface 306 sends commands to the drones 104 via any type of flight controller 308. The flight controller 308 communicates with the drones 104 via the cellular telephone tower 115, a wireless access point (AP), a wireless hotspot, etc. In the illustrated example of FIG. 3, the flight controller 308 is part of the flight system 128. In other examples, the flight controller 308 is separate from the flight system 128.

In some examples, the user interface 302 enables the user 116 to control the configuration of content and flight plans onto the drones 104, and/or to initiate the activation, control, flying, etc. of the drones 104. In some examples, the drone display design system 188 and the example flight system 128 are implemented together. In some examples, the flight controller 308 is implemented together with the flight system 128.

While an example manner of implementing the flight system 128 of FIG. 1 is illustrated in FIG. 3, one or more of the elements, processes and/or devices illustrated in FIG. 3 may be combined, divided, re-arranged, omitted, eliminated and/or implemented in any other way. Further, the example content mapper 302, the example flight planner 304, the example drone control interface 308, the example flight controller 308 and/or, more generally, the example flight system 128 of FIG. 3 may be implemented by hardware, software, firmware and/or any combination of hardware, software and/or firmware. Thus, for example, any of the example content mapper 302, the example flight planner 304, the example drone control interface 308, the example flight controller 308 and/or, more generally, the example flight system 128 could be implemented by one or more analog or digital circuit(s), logic circuits, programmable processor(s), programmable controller(s), GPU(s), DSP(s), ASIC(s), PLD(s) and/or FPLD(s). When reading any of the apparatus or system claims of this patent to cover a purely software and/or firmware implementation, at least one of the example content mapper 302, the example flight planner 304, the example drone control interface 308, the example flight controller 308 and/or the example flight system 128 is/are hereby expressly defined to include a non-transitory computer-readable storage device or storage disk such as a memory, a DVD, a CD, a Blu-ray disk, etc. including the software and/or firmware. Further still, the example flight system 128 of FIG. 3 may include one or more elements, processes and/or devices in addition to, or instead of, those illustrated in FIG. 3, and/or may include more than one of any or all the illustrated elements, processes and devices.

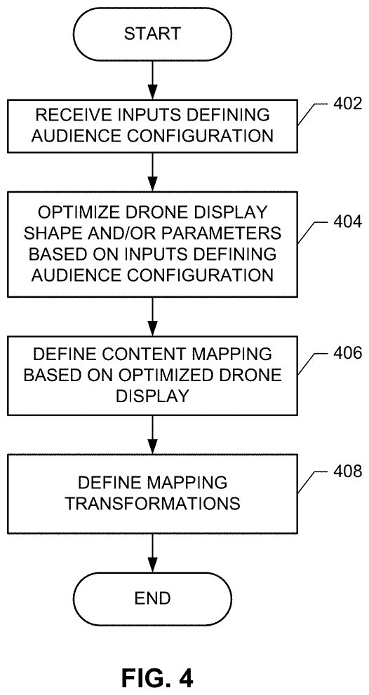

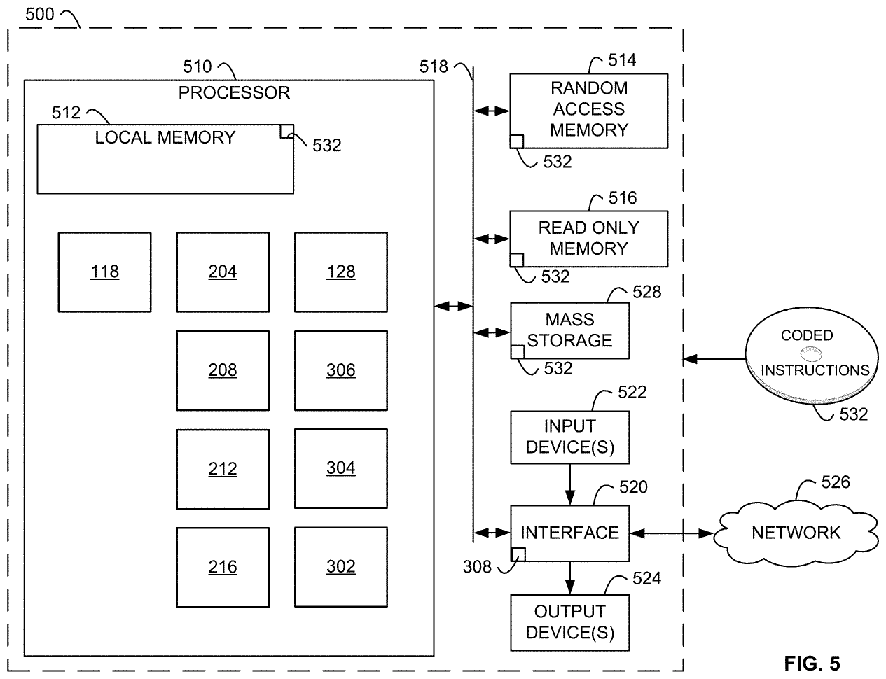

A flowchart representative of example hardware logic or machine-readable instructions for implementing the drone display designer system 188 of FIG. 2 is shown in FIG. 4. The machine-readable instructions may be a program or portion of a program for execution by a processor such as the processor 510 shown in the example processor platform 500 discussed below in connection with FIG. 5. The program may be embodied in software stored on a non-transitory computer-readable storage medium such as a compact disc read-only memory (CD-ROM), a floppy disk, a hard drive, a DVD, a Blu-ray disk, or a memory associated with the processor 510, but the entire program and/or parts thereof could alternatively be executed by a device other than the processor 510 and/or embodied in firmware or dedicated hardware. Further, although the example program is described with reference to the flowchart illustrated in FIG. 4, many other methods of implementing the example drone display designer system 188 may alternatively be used. For example, the order of execution of the blocks may be changed, and/or some of the blocks described may be changed, eliminated, or combined. Additionally, and/or alternatively, any or all the blocks may be implemented by one or more hardware circuits (e.g., discrete and/or integrated analog and/or digital circuitry, an FPGA, an ASIC, a comparator, an operational-amplifier (op-amp), a logic circuit, etc.) structured to perform the corresponding operation without executing software or firmware.

As mentioned above, the example processes of FIG. 4 may be implemented using executable instructions (e.g., computer and/or machine-readable instructions) stored on a non-transitory computer and/or machine-readable medium such as a hard disk drive, a flash memory, a read-only memory, a CD-ROM, a DVD, a cache, a random-access memory and/or any other storage device or storage disk in which information is stored for any duration (e.g., for extended time periods, permanently, for brief instances, for temporarily buffering, and/or for caching of the information). As used herein, the term non-transitory computer-readable medium is expressly defined to include any type of computer-readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc. may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, and (6) B with C.

The program of FIG. 4 begins at block 402, where the audience configuration definer 204 receives inputs 120 from the user 116 defining the configuration of an audience (block 402). The drone display designer 208 optimizes the shape of the drone display 106 based on the configuration of the audience (block 404). The content map definer 212 determines the map from the content 124 to the drone display (block 406), and the content transform definer 216 defines any mapping transformations that are need (e.g., for example if a drone display is dynamic (block 408).

FIG. 5 is a block diagram of an example processor platform 500 structured to execute the instructions of FIG. 4 to implement the drone display design system 188 of FIG. 2 and the example flight system 128 of FIG. 3. The processor platform 500 can be, for example, a server, a personal computer, a workstation, a mobile device (e.g., a cell phone, a smart phone, a tablet such as an IPAD™), or any other type of computing device.

The processor platform 500 of the illustrated example includes a processor 510. The processor 510 of the illustrated example is hardware. For example, the processor 510 can be implemented by one or more integrated circuits, logic circuits, microprocessors, GPUs, DSPs, or controllers from any desired family or manufacturer. The hardware processor may be a semiconductor based (e.g., silicon based) device. In this example, the processor implements the example audience configuration definer 204, the example drone display designer 208, the example content map definer 212, the example content transform definer 216, the example drone display design system 188, the example content mapper 302, the example flight planner 304, the example drone control interface 308, the example flight controller 308 and/or the example flight system 128.

The processor 510 of the illustrated example includes a local memory 512 (e.g., a cache). The processor 510 of the illustrated example is in communication with a main memory including a volatile memory 514 and a non-volatile memory 516 via a bus 518. The volatile memory 514 may be implemented by Synchronous Dynamic Random-Access Memory (SDRAM), Dynamic Random-Access Memory (DRAM), RAMBUS® Dynamic Random-Access Memory (RDRAM®) and/or any other type of random access memory device. The non-volatile memory 516 may be implemented by flash memory and/or any other desired type of memory device. Access to the main memory 514, 516 is controlled by a memory controller.

The processor platform 500 of the illustrated example also includes an interface circuit 520. The interface circuit 520 may be implemented by any type of interface standard, such as an Ethernet interface, a universal serial bus (USB), a Bluetooth® interface, a near field communication (NFC) interface, and/or a PCI express interface. In the illustrated example, the interface circuit 520 implements the example flight controller 308.

In the illustrated example, one or more input devices 522 are connected to the interface circuit 520. The input device(s) 522 permit(s) a user to enter data and/or commands into the processor 510. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 524 are also connected to the interface circuit 520 of the illustrated example. The output devices 524 can be implemented, for example, by display devices (e.g., a light emitting diode (LED), an organic light emitting diode (OLED), a liquid crystal display (LCD), a cathode ray tube display (CRT), an in-place switching (IPS) display, a touchscreen, etc.), a tactile output device, a printer and/or speaker. The interface circuit 520 of the illustrated example, thus, typically includes a graphics driver card, a graphics driver chip and/or a graphics driver processor.

The interface circuit 520 of the illustrated example also includes a communication device such as a transmitter, a receiver, a transceiver, a modem, a residential gateway, a wireless access point, and/or a network interface to facilitate exchange of data with external machines (e.g., computing devices of any kind) via a network 526. The communication can be via, for example, an Ethernet connection, a digital subscriber line (DSL) connection, a telephone line connection, a coaxial cable system, a satellite system, a line-of-site wireless system, a cellular telephone system, etc.

The processor platform 500 of the illustrated example also includes one or more mass storage devices 528 for storing software and/or data. Examples of such mass storage devices 528 include floppy disk drives, hard drive disks, CD drives, Blu-ray disk drives, redundant array of independent disks (RAID) systems, and DVD drives.

Coded instructions 532 including the coded instructions of FIG. 4 may be stored in the mass storage device 528, in the volatile memory 514, in the non-volatile memory 516, and/or on a removable non-transitory computer-readable storage medium such as a CD-ROM or a DVD.

Example methods and apparatus to create drone displays are disclosed herein. Further examples and combinations thereof include at least the following.

Example 1 is a drone display system that includes:

an audience configuration definer to receive an input representing a configuration of an audience from a user; and

a drone display designer to, by executing an instruction with a processor, design a drone display to present content to the audience based on the input.

Example 2 is the drone display design system of Example 1, wherein the drone display designer is to, by executing an instruction with a processor, design the drone display using parameter optimization.

Example 3 is the drone display design system of Example 2, wherein using the parameter optimization includes at least one of a stochastic gradient descent, or the Euler-Lagrange differential equation.

Example 4 is the drone display design system of Example 1, wherein the drone display designer is to, by executing an instruction with a processor, design the drone display by identifying a geometry that increases a number of audience members viewing the drone display at a perpendicular angle to the drone display.

Example 5 is the drone display design system of Example 1, wherein the drone display designer is to:

identify two drone display options; and

receive a second input from the user selecting one of the two drone display options.

Example 6 is the drone display design system of Example 1, wherein the drone display designer is to:

receive a second input representing a change to the drone display; and

modify the drone display according to the second input.

Example 7 is the drone display design system of Example 1, wherein the drone display designer is to design the drone display for a first portion of the audience, and design a second drone display to present the content to a second portion of the audience based on the input.

Example 8 is the drone display design system of Example 1, further including:

a flight planner to allocate portions of the content to respective drones of the drone display; and

a flight controller to fly the drones to form the drone display, and to present the content on the drone display.

Example 9 is a method, comprising:

receiving an input representing a configuration of an audience from a user; and

performing parameter optimization to design a drone display to present content to the audience based on the input.

Example 10 is the method of Example 9, wherein performing the parameter optimization includes at least one of a stochastic gradient descent, or the Euler-Lagrange differential equation.

Example 11 is the method of Example 9, wherein designing the drone display including identifying a geometry that increases a number of audience members viewing the drone display at a perpendicular angle to the drone display.

Example 12 is the method of Example 9, wherein designing the drone display includes:

identify two drone display options; and

receive a second input from the user selecting one of the two drone display options.

Example 13 is the method of Example 9, wherein designing the drone display includes designing the drone display for a first portion of the audience, and designing a second drone display for a second portion of the audience.

Example 14 is a non-transitory computer-readable storage medium comprising instructions that, when executed, cause a machine to:

receive an input representing a configuration of an audience from a user;

design a drone display to present content to the audience based on the input;

allocate portions of the content to respective drones of the drone display; and

fly the drones to form the drone display, and to present the content on the drone display.

Example 15 is the non-transitory computer-readable storage medium of Example 14, including instructions that, when executed, cause the machine to design the drone display using parameter optimization.

Example 16 is the non-transitory computer-readable storage medium of Example 15, including instructions that, when executed, cause the machine to perform the parameter optimization using at least one of a stochastic gradient descent, or the Euler-Lagrange differential equation.

Example 17 is the non-transitory computer-readable storage medium of Example 14, including instructions that, when executed, cause the machine to design the drone display by identifying a geometry that increases a number of audience members viewing the drone display at a perpendicular angle to the drone display.

Example 18 is the non-transitory computer-readable storage medium of Example 14, including instructions that, when executed, cause the machine to:

identify two drone display options; and

receive a second input from the user selecting one of the two drone display options.

Example 19 is the non-transitory computer-readable storage medium of Example 14, including instructions that, when executed, cause the machine to design the drone display for a first portion of the audience, and designing a second drone display for a second portion of the audience.

Example 20 is drone display design system, including:

an audience configuration definer to receive an input representing a configuration of an audience from a user; and

a drone display designer to, by executing an instruction with a processor, design a drone display to present content to the audience based on the input.

Example 21 is the drone display design system of Example 20, wherein the drone display designer is to, by executing an instruction with a processor, design the drone display using parameter optimization.

Example 22 is the drone display design system of Example 21, wherein using the parameter optimization includes at least one of a stochastic gradient descent, or the Euler-Lagrange differential equation.

Example 23 is the drone display design system of any of Examples 20 to 22, wherein the drone display designer is to, by executing an instruction with a processor, design the drone display by identifying a geometry that increases a number of audience members viewing the drone display at a perpendicular angle to the drone display.

Example 24 is the drone display design system of any of Examples 20 to 23, wherein the drone display designer is to:

identify two drone display options; and

receive a second input from the user selecting one of the two drone display options.

Example 25 is the drone display design system of any of Examples 20 to 24, wherein the drone display designer is to:

receive a second input representing a change to the drone display; and

modify the drone display according to the second input.

Example 26 is the drone display design system of any of Examples 20 to 25, wherein the drone display designer is to design the drone display for a first portion of the audience, design a second drone display to present the content to a second portion of the audience based on the input.

Example 27 is the drone display design system of any of Examples 20 to 26, further including:

a flight planner to allocate portions of the content to respective drones of the drone display; and

a flight controller to fly the drones to form the drone display, and to present the content on the drone display.

Example 28 is a method, including:

receiving an input representing a configuration of an audience from a user; and

performing parameter optimization to design a drone display to present content to the audience based on the input.

Example 29 is the method of Example 28, wherein performing the parameter optimization includes at least one of a stochastic gradient descent, or the Euler-Lagrange differential equation.

Example 30 is the method of Example 28 or Example 29, wherein designing the drone display including identifying a geometry that increases a number of audience members viewing the drone display at a perpendicular angle to the drone display.

Example 31 is the method of any of Examples 28 to 30, wherein designing the drone display includes:

identify two drone display options; and

receive a second input from the user selecting one of the two drone display options.

Example 32 is the method of any of Examples 28 to 31, wherein designing the drone display includes designing the drone display for a first portion of the audience, and designing a second drone display for a second portion of the audience.

Example 33 is a non-transitory computer-readable storage medium comprising instructions that, when executed, cause a computer processor to perform the method of any of Examples 28 to 32.

Example 34 is a non-transitory computer-readable storage medium comprising instructions that, when executed, cause a machine to:

receive an input representing a configuration of an audience from a user;

design a drone display to present content to the audience based on the input;

allocate portions of the content to respective drones of the drone display; and

fly the drones to form the drone display, and to present the content on the drone display.

Example 35 is the non-transitory computer-readable storage medium of Example 34, including instructions that, when executed, cause the machine to design the drone display using parameter optimization.

Example 36 is the non-transitory computer-readable storage medium of Example 35, including instructions that, when executed, cause the machine to perform the parameter optimization using at least one of a stochastic gradient descent, or the Euler-Lagrange differential equation.

Example 37 is the non-transitory computer-readable storage medium of any of Examples 34 to 36, including instructions that, when executed, cause the machine to design the drone display by identifying a geometry that increases a number of audience members viewing the drone display at a perpendicular angle to the drone display.

Example 38 is the non-transitory computer-readable storage medium of any of Examples 34 to 37, including instructions that, when executed, cause the machine to:

identify two drone display options; and

receive a second input from the user selecting one of the two drone display options.

Example 39 is the non-transitory computer-readable storage medium of any of Examples 34 to 38, including instructions that, when executed, cause the machine to design the drone display for a first portion of the audience, and designing a second drone display for a second portion of the audience.

Example 40 is a system, including:

a means for receiving an input representing a configuration of an audience from a user; and

a means for designing a drone display to present content to the audience based on the input.

Example 41 is the system of example 40, wherein the means for designing uses parameter optimization.

Example 42 is the system of example 41, wherein the parameter optimization includes at least one of a stochastic gradient descent, or the Euler-Lagrange differential equation.

Example 43 is system of any of Examples 40 to 42, wherein the means for designing identifies a geometry that increases a number of audience members viewing the drone display at a perpendicular angle to the drone display.

Example 44 is system of any of Examples 40 to 43, wherein the means for designing:

identifies two drone display options; and

receives a second input from the user selecting one of the two drone display options.

Example 45 is system of any of Examples 40 to 44, wherein the means for designing:

receives a second input representing a change to the drone display; and

modifies the drone display according to the second input.

Example 46 is system of any of Examples 40 to 45, wherein the means for designing designs the drone display for a first portion of the audience, and designs a second drone display to present the content to a second portion of the audience based on the input.

Example 47 is system of any of Examples 40 to 46, further including:

a means for allocating portions of the content to respective drones of the drone display; and

a means for flying the drones to form the drone display, and to present the content on the drone display.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

1-28. (canceled)

29. A drone display design genie, comprising:
an audience configuration definer to receive an input representing a configuration of an audience from a user; and
a drone display designer to, by executing an instruction with a processor, design a drone display to present content to the audience based on the input.

30. The drone display design genie of claim 29, wherein the drone display designer is to, by executing an instruction with a processor, design the drone display using parameter optimization.

31. The drone display design genie of claim 30, wherein using the parameter optimization includes at least one of a stochastic gradient descent, or the Euler-Lagrange differential equation.

32. The drone display design genie of claim 29, wherein the drone display designer is to, by executing an instruction with a processor, design the drone display by identifying a geometry that increases a number of audience members viewing the drone display at a perpendicular angle to the drone display.

33. The drone display design genie of claim 29, wherein the drone display designer is to:
identify two drone display options; and
receive a second input from the user selecting one of the two drone display options.

34. The drone display design genie of claim 29, wherein the drone display designer is to:
receive a second input representing a change to the drone display; and
modify the drone display according to the second input.

35. The drone display design genie of claim 29, wherein the drone display designer is to design the drone display for a first portion of the audience, and design a second drone display to present the content to a second portion of the audience based on the input.

36. The drone display design genie of claim 29, further including:
a flight planner to allocate portions of the content to respective drones of the drone display; and
a flight controller to fly the drones to form the drone display, and to present the content on the drone display.

37. A method, comprising:
receiving an input representing a configuration of an audience from a user; and
performing parameter optimization to design a drone display to present content to the audience based on the input.

38. The method of claim 37, wherein performing the parameter optimization includes at least one of a stochastic gradient descent, or the Euler-Lagrange differential equation.

39. The method of claim 37, wherein designing the drone display including identifying a geometry that increases a number of audience members viewing the drone display at a perpendicular angle to the drone display.

40. The method of claim 37, wherein designing the drone display includes:
identify two drone display options; and
receive a second input from the user selecting one of the two drone display options.

41. The method of claim 37, wherein designing the drone display includes designing the drone display for a first portion of the audience, and designing a second drone display for a second portion of the audience.

42. A non-transitory computer-readable storage medium comprising instructions that, when executed, cause a machine to:
receive an input representing a configuration of an audience from a user;
design a drone display to present content to the audience based on the input;
allocate portions of the content to respective drones of the drone display; and
fly the drones to form the drone display, and to present the content on the drone display.

43. The non-transitory computer-readable storage medium of claim 42, including instructions that, when executed, cause the machine to design the drone display using parameter optimization.

44. The non-transitory computer-readable storage medium of claim 43, including instructions that, when executed, cause the machine to perform the parameter optimization using at least one of a stochastic gradient descent, or the Euler-Lagrange differential equation.

45. The non-transitory computer-readable storage medium of claim 42, including instructions that, when executed, cause the machine to design the drone display by identifying a geometry that increases a number of audience members viewing the drone display at a perpendicular angle to the drone display.

46. The non-transitory computer-readable storage medium of claim 42, including instructions that, when executed, cause the machine to:
identify two drone display options; and
receive a second input from the user selecting one of the two drone display options.

47. The non-transitory computer-readable storage medium of claim 42, including instructions that, when executed, cause the machine to design the drone display for a first portion of the audience, and designing a second drone display for a second portion of the audience.
